(19) United States
(12) Patent Application Publication
(10) Pub. No.: US 2005/0241456 A1
(43) Pub. Date: Nov. 3, 2005

(54) Multi-layer pick guard devices and methods therefor

(76) Inventors: Mark K. Nakamura, Las Vegas, NV (US); Kathy L. Sugitaya, Las Vegas, NV (US)

Correspondence Address: WEISS & MOY PC, 4204 NORTH BROWN AVENUE, SCOTTSDALE, AZ, 85251, US

(21) Appl. No.: 10/836,412

(22) Filed: May 3, 2004

(51) Int. Cl. G10H 3/18; G10D 3/16

(52) U.S. Cl. 84/322

(57) ABSTRACT

A pick guard device comprises a pick guard assembly having a multiplicity of layers, with each layer coupled to an adjacent layer of the multiplicity of layers. The back side of a final layer of the multiplicity of layers is detachably coupled to a portion of a surface adjacent to a sound hole of a stringed musical instrument, thereby enabling a person to non-adhesively couple the pick guard device to the portion of the surface adjacent to the sound hole and to non-destructively decouple the pick guard device from the portion of the surface adjacent to the sound hole of the stringed musical instrument. The pick guard device is replaced with another pick guard device according to the mood of a person using the stringed musical instrument and the desire of the person to portray a theme to an audience.

### FIELD OF THE INVENTION

This invention relates generally to pick guards for stringed musical instruments and more specifically to improved multi-layer pick guard devices in combination with a musical stringed instrument and methods for detachably applying multi-layer pick guard devices to a surface of the stringed musical instrument without permanently damaging the surface of the stringed musical instrument.

### BACKGROUND OF THE INVENTION

In the past, pick guards have been permanently attached to the surface of a musical instrument such as a guitar to protect the surface proximate to the strings of the musical instrument from excessive wear. Typically, such pick guards have been made of a rigid material that is bonded or otherwise mechanically secured to the surface of the guitar. For example, Sica, U.S. Pat. No. 5,517,891 disclosed a pick guard mounted by screws on a guitar having three layers; a top layer made of fabric, a middle layer made of a flexible rubber, plastic or vinyl material and a bottom layer made of a soft felt material.

It is desirable to provide a pick guard that requires no permanent mounting to a surface of the musical instrument so that no permanent alteration is made to the surface of the musical instrument. Casamento, U.S. Application 20030140763 disclosed a finish protecting device for stringed musical instruments consisting of a device made from static-cling vinyl or a material of similar properties. According to Casamento, U.S. Application 20030140763, the device is readily shaped and sized to conform to the area requiring protection and may be repeatedly attached and remove without damage to the instrument's finish or degradation in adhesive qualities. In the preferred embodiment Casamento, U.S. Application 20030140763 shows the finish protecting device on a rear surface of an acoustic guitar and emphasizes that the finish protecting device is made to conform to the shape and size of the protected area. Additionally, Casamento, U.S. Application 20030140763 disclosed that the finish protecting device may be clear or solid colorations so that the clear embodiment would show the surface being protected, while the solid coloration embodiment would hide imperfections in the surface of musical instruments. Most important, the finish protecting device of Casamento, U.S. Application 20030140763 is a single layer product.

In the same vein as Casamento, U.S. Application 20030140763, a recent (February, 2004) internet disclosure on eBay showed a clear pick guard that is a protective plastic overlay. No solid or decorative pick guards were shown. Additionally, the internet clear pick guard is a single layer product.

The present inventors have recognized the need for removable pick guards and furthermore have recognized the further need for an improved pick guard device which not only protects the surface of musical instruments, but also provide a decorative function that can be rapidly changed according to the needs of a musician in a professional setting. The present inventors' pick guard device embodiments are pre-shaped to conform to the area near the strings of musical instruments so that there is no need to shape and size the pick guard device embodiments. For the present inventors' pick guard device a musician merely removes and replaces a pick guard device embodiment with another pick guard device embodiment according to the mood of the musician and desire to portray a theme to an audience. In order to provide pick guard device embodiments having a decorative function, as well as a protective function, the present inventors disclose a multi-layer structure for the pick guard device embodiments. Accordingly, it will be apparent to those skilled in the art that the present inventors' decorative pick guard device embodiments are an improvement over the previously described pick guards and finish protecting devices.

### SUMMARY OF THE INVENTION

Accordingly, it is an object of this disclosure to provide improved pick guard devices.

It is a further object of this disclosure to provide improved pick guard devices in combination with a stringed musical instrument.

It is a still further object of this disclosure to provide improved multilayered pick guard devices.

It is a yet further object of this disclosure to provide improved pick guard devices readily interchangeable by a person.

It is a further object of this disclosure to provide methods for using improved multilayered pick guard devices which are readily interchangeable by a person to a surface of a stringed musical instrument without damaging the surface of the stringed musical instrument.

### PREFERRED EMBODIMENTS OF THE INVENTION

In accordance with one embodiment of this invention, a combination pick guard device and a stringed musical instrument comprises in combination, a pick guard assembly provided with a first layer having a front side and a back side and the pick guard assembly is provided with a second layer having a front side and a back side, the back side of the first layer of the pick guard assembly being coupled to the front side of the second layer of the pick guard assembly. A stringed musical instrument is coupled to the pick guard device and the back side of the second layer of the pick guard assembly is detachably coupled to a portion of the surface of the stringed musical instrument thereby facilitating non-destructive removal of the pick guard device from the portion of the surface of the stringed musical instrument.

In accordance with a second embodiment of this invention, a pick guard device comprises in combination, a pick guard assembly having a multiplicity of layers, each layer of the multiplicity of layers of the pick guard assembly being coupled to an adjacent layer of the multiplicity of layers of the pick guard assembly. A back side of a final layer of the multiplicity of layers of the pick guard assembly is adapted to be detachably coupled to a portion of a surface of a stringed musical instrument adjacent to a sound hole thereof, thereby permitting rapid non-adhesive coupling of the pick guard device to the portion of the surface adjacent to the sound hole of the stringed musical instrument and also permitting non-destructive decoupling of the pick guard device from the portion of the surface adjacent to the sound hole of the stringed musical instrument.

In accordance with a third embodiment of this invention, a method for using a pick guard device comprises the steps of providing a pick guard assembly having a multiplicity of layers, each layer of the multiplicity of layers of the pick guard assembly coupled to an adjacent layer of the multiplicity of layers of the pick guard assembly; and providing a back side of a final layer of the multiplicity of layers of the pick guard assembly being adapted to be detachably coupled to a portion of a surface of a stringed musical instrument adjacent to a sound hole thereof, thereby permitting rapid non-adhesive coupling of the pick guard device to the portion of the surface adjacent to the sound hole of the stringed musical instrument and also permitting non-destructive decoupling of the pick guard device from the portion of the surface adjacent to the sound hole of the stringed musical instrument. The method further comprises the steps of decoupling the back side of the final layer of the multiplicity of layers of the pick guard assembly of the pick guard device from the portion of the surface adjacent to the sound hole of the stringed musical instrument; replacing the pick guard device with a replacement pick guard device, according to the mood of a person using the stringed musical instrument and also the desire of said person to portray a theme to an audience, the replacement pick guard device including a replacement pick guard assembly having a front side and a back side; and coupling the back side of the replacement pick guard assembly of the replacement pick guard device to a portion of the surface adjacent to the sound hole of the stringed musical instrument.

The foregoing and other objects, features, and advantages of the invention will be apparent from the following, more detailed description of the preferred embodiments of the invention, as illustrated in the accompanying drawings.

### BRIEF DESCRIPTION OF THE DRAWINGS

FIG. 1 is a perspective view showing a stringed musical instrument with one embodiment of a pick guard device coupled to a portion of the front surface of the according to the present invention.

FIG. 2 is a perspective view showing the pick guard device of FIG. 1.

FIG. 3 is an elevational view showing a front side of the pick guard device of FIG. 1.

FIG. 4 is a sectional view through 4-4 of FIG. 3 of a pick guard assembly of the pick guard device of FIG. 1 showing the pick guard assembly having a plurality of layers.

FIG. 5 is an elevational view showing a front side of a second embodiment of a pick guard device.

### DESCRIPTION OF THE INVENTION

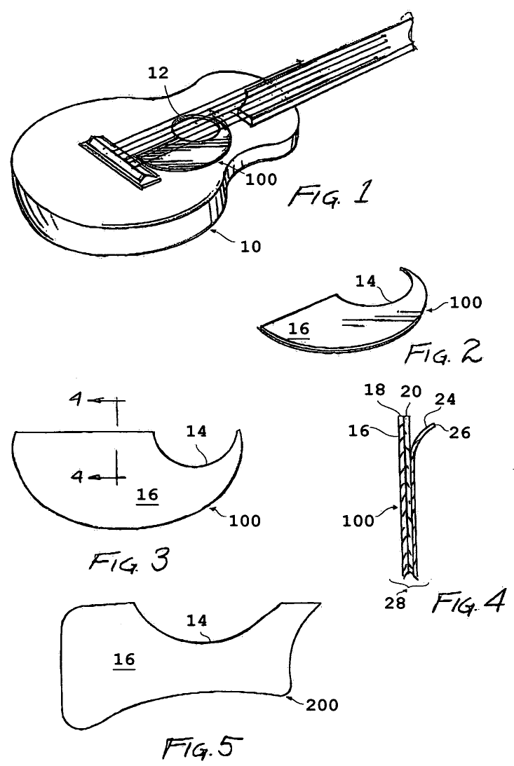

According to FIG. 1, in one embodiment of a pick guard device 100 and a stringed musical instrument 10 having a sound hole 12, the pick guard device 100 is coupled to a portion of a surface of the stringed musical instrument 10. The pick guard device 100 is shown (see FIG. 1) adjacent to a portion of the sound hole 12 of the stringed musical instrument 10. The pick guard device 100 may comprise various decorative features including musical notes, flowers, differing colors, differing textures, differing scenes and differing themes such as portions of flags, patriotic symbols, messages and sub-scenes. It is understood that the pick guard device 100 may comprise many other decorative features.

Referring to FIG. 2, the pick guard device 100 has a concave shaped portion 14 that is for positioning the pick guard device 100 adjacent to the sound hole 12 of the stringed musical instrument 10. The pick guard device 100 further comprises a pick guard assembly 28 (not shown in FIG. 2, but shown in FIG. 4) having a front side 16 of a first layer 18 of the pick guard assembly 28 of the pick guard device 100 to protect a portion of the surface adjacent to the sound hole 12 of the stringed musical instrument 10 when a person strums the strings of the stringed musical instrument 10. A back side 22 of a second layer 20 of the surface of the pick guard assembly 28 of the pick guard device 100 (not shown in FIG. 2, but shown in FIG. 4) is detachably coupled to a portion of the surface adjacent to the sound hole 12 of the stringed musical instrument 10. Since the back side 22 of the second layer 20 of the pick guard assembly 28 of the pick guard device 100 is detachably coupled to the stringed musical instrument 10, a person using the pick guard device 100 may readily change the pick guard device 100 for another pick guard device such as a second embodiment of the pick guard device 200 (see FIG. 5) or another decorated embodiment of the pick guard device 100. In addition, when the back side 22 of the second layer 20 of the pick guard assembly 28 of the pick guard device 100 is removed from a portion of the surface adjacent to the sound hole 12 of the stringed musical instrument 10, the surface of the stringed musical instrument 10 is not damaged since no adhesive is used to couple the pick guard assembly 28 of the pick guard device 100 to a portion of the surface adjacent to the sound hole 12 of the stringed musical instrument 10. Preferably, the pick guard device 100 comprises a substantially flexible thermoplastic such as a polymer or a copolymer of polyethylene, polypropylene, polyester, nylon, polyvinyl chloride and the like so that the pick guard device 100 may conform to a portion of the surface of the stringed musical instrument 10. FIG. 3 shows an elevational view of the front side 16 of the first layer 18 of the pick guard assembly 28 of the pick guard device 100.

FIG. 4 is a sectional view through 4-4 of FIG. 3 of the pick guard assembly 28 of the pick guard device 100 showing the pick guard assembly 28 having the first layer 18, the second layer 20 and a third layer 26. A back side of the first layer 18 of the pick guard assembly 28 is coupled to a front side of the second layer 20 of the pick guard assembly 28 of the pick guard device 100 and the back side 22 of the second layer 20 of the pick guard assembly 28 is detachably coupled to a back side 24 of the third layer 26 of the pick guard assembly 28 of the pick guard device 100. The third layer 26 of the pick guard assembly 28 protects the back side 22 of the second layer 20 of the pick guard assembly 28 of the pick guard device 100 while the pick guard 100 device is not used, and a person using the pick guard device 100 may dispose of the third layer 26 of the pick guard assembly 28 after the first use of the pick guard device 100. Either the first layer 18 or the second layer 20 of the pick guard assembly 28 of the pick guard device 100 may comprise the decorative features described above. The decorative features of the pick guard device 100 may be embedded in the thermoplastic polymer or alternatively may be laminated (not shown) to a portion of the surface of either the first layer 18 or the second layer 20 of the pick guard assembly 28 of the pick guard device 100. Preferably, the back side of the first layer 18 of the pick guard assembly 28 is laminated to the first side of the second layer 20 of the pick guard assembly 28 of the pick guard device 100. An adhesive may be applied between the back side of the first layer 18 and the first side of the second layer 20 of the pick guard assembly 28 of the pick guard device 100. Alternatively, the back side of the first layer 18 of the pick guard assembly 28 may be heat welded to the first side of the second layer 20 of the pick guard assembly 28 of the pick guard device 100.

It is understood that the pick guard device 100 may comprise a pick guard assembly 28 having a multiplicity of layers, where each one of the layers of the multiplicity of layers of the pick guard assembly 28 is coupled to an adjacent layer of the multiplicity of layers of the pick guard assembly 28 and a back side of a final layer of the multiplicity of layers of the pick guard assembly 28 is detachably coupled to a portion of the surface adjacent to the sound hole 12 of the stringed musical instrument 10. The pick guard assembly 28 of the pick guard device 100 may further comprise a disposable layer 26 having a front side and a back side, where the front side of the disposable layer 26 of the pick guard assembly 28 is detachably coupled to the back side of the final layer of the multiplicity of layers of the pick guard assembly 28 of the pick guard device 100. The disposable layer 26 of the pick guard assembly 28 protects the back side of the final layer of the multiplicity of layers of the pick guard assembly 28 of the pick guard device 100. The front side of the disposable layer 26 is decoupled from the back side of the final layer of the multiplicity of layers of the pick guard assembly 28 of the pick guard device 100 prior to coupling the back side of the final layer of the multiplicity of layers of the pick guard assembly 28 of the pick guard device 100 to the portion of the surface adjacent to the sound hole 12 of the stringed musical instrument 10.

FIG. 5 is an elevational view showing a front side 16 of a pick guard assembly 28 of a second embodiment of a pick guard device 200. The pick guard device 200 having the pick guard assembly 28 is similar to the first embodiment of the pick guard device 100 having the pick guard assembly 28 (see description above) except for a difference in the shape of the pick guard device 200 (compare FIG. 3 to FIG. 5).

In using the pick guard device 100 (and similarly for the pick guard device 200), a person selects the pick guard device 100 (or alternatively, the pick guard device 200) and couples a back side of a pick guard assembly 28 of the selected pick guard 100 to a portion of the surface adjacent to the sound hole 12 of the stringed musical instrument 10. The person using the pick guard device 100, may decouple the back side of the pick guard assembly 28 of the pick guard device 100 from the portion of the surface adjacent to the sound hole 12 of the stringed musical instrument 10 and then replace the pick guard device 100 with a replacement pick guard device having a replacement pick guard assembly (similar to either one of the pick guard device 100 and the pick guard device 200). The replacement pick guard assembly of the replacement pick guard device has a front side and a back side. The back side of the replacement pick guard assembly of the replacement pick guard device is coupled to a portion of the surface adjacent to the sound hole 12 of the stringed musical instrument 10, according to the mood of the person using the stringed musical instrument 10 and also the desire of the person to portray a theme to an audience. It is understood that the method for using the pick guard assembly 28 of the pick guard device 100 (described above) includes a pick guard assembly 28 having a multiplicity of layers.

While the invention has been particularly shown and described with reference to preferred embodiments thereof, it will be understood by those skilled in the art that the foregoing and other changes in form and details may be made therein without departing from the spirit and scope of the invention. For example, the pick guard device may comprise a thermoset plastic material as well as a combination of thermoset and thermoplastic materials. Additionally, at least one of the layers of the pick guard assembly of the pick guard may comprise a metallic foil or a plastic layer having a filler such as a metallic powder, inorganic material (such as calcium carbonate, titanium dioxide, pigments and ground semi-precious materials and the like) embedded in the plastic layer of the pick guard assembly. The pick guard device may be opaque or translucent, or a portion of the pick guard device may be transparent. For a left handed person, the pick guard device may be coupled to an opposite portion of the sound hole of the stringed musical instrument compared with the orientation of a right handed person.

1. A combination pick guard device and a stringed musical instrument comprising in combination:
a pick guard assembly provided with a first layer having a front side and a back side;
said pick guard assembly provided with a second layer having a front side and a back side, said back side of said first layer of said pick guard assembly coupled to said front side of said second layer of said pick guard assembly;
a stringed musical instrument coupled to said pick guard device; and
said back side of said second layer of said pick guard assembly detachably coupled to a portion of the surface of said stringed musical instrument thereby facilitating non-destructive removal of said pick guard device from said portion of the surface of said stringed musical instrument.

2. The combination pick guard device and a stringed musical instrument according to claim 1 wherein said stringed musical instrument having a sound hole, a back side of said pick guard assembly of said pick guard device detachably coupled to a portion of the surface of said stringed musical instrument adjacent to said sound hole thereby decorating and protecting said portion of the surface of said stringed musical instrument.

3. The pick guard device and a stringed musical instrument according to claim 1 further comprising
a third layer of said pick guard assembly having a front side and a back side, said front side of said third layer of said pick guard assembly detachably coupled to said back side of said second layer of said pick guard assembly, said third layer of said pick guard assembly protecting said back side of said second layer of said pick guard assembly; and
said front side of said third layer of said pick guard assembly decoupled from said back side of said second layer of said pick guard assembly prior to coupling said back side of said second layer of said pick guard assembly to a portion of the surface of said musical instrument.

4. The pick guard device and a stringed musical instrument according to claim 1 further comprising a substantially flexible thermoplastic so that said pick guard device conforms to a portion of the surface of said stringed musical instrument when said back side of said second layer of said pick guard assembly is coupled to said portion of the surface of said stringed musical instrument.

5. The pick guard device and a stringed musical instrument according to claim 4 wherein said thermoplastic is at least one of polyethylene, polypropylene, polyester, nylon and polyvinyl chloride.

6. The pick guard device and a stringed musical instrument according to claim 4 further comprising a filler embedded in said flexible thermoplastic.

7. The pick guard device and a stringed musical instrument according to claim 4 further comprising at least a foil coupled to said thermoplastic.

8. The pick guard device and a stringed musical instrument according to claim 1 wherein at least a portion of said pick guard assembly is at least one of opaque, translucent and transparent.

9. A pick guard device comprising in combination:
a pick guard assembly having a multiplicity of layers, each layer of said multiplicity of layers of said pick guard assembly coupled to an adjacent layer of said multiplicity of layers of said pick guard assembly; and
a back side of a final layer of said multiplicity of layers of said pick guard assembly adapted to be detachably coupled to a portion of a surface of a stringed musical instrument adjacent to a sound hole thereof, thereby permitting rapid non-adhesive coupling of said pick guard device to said portion of the surface adjacent to said sound hole of said stringed musical instrument and also permitting non-destructive decoupling of said pick guard device from said portion of the surface adjacent to said sound hole of said stringed musical instrument.

10. The pick guard device according to claim 9 further comprising
a disposable layer of said pick guard assembly having a front side and a back side, said front side of said disposable layer of said pick guard assembly detachably coupled to said back side of said final layer of said multiplicity of layers of said pick guard assembly, said disposable layer of said pick guard assembly protecting said back side of said final layer of said multiplicity of layers of said pick guard assembly; and
said front side of said disposable layer of said pick guard assembly decoupled from said back side of said final layer of said multiplicity of layers of said pick guard assembly prior to coupling said back side of said final layer of said multiplicity of layers of said pick guard assembly to said portion of the surface adjacent to said sound hole of said stringed musical instrument.

11. The pick guard device having a pick guard assembly according to claim 9 wherein at least one layer of said multiplicity of layers of said pick guard assembly further comprising a substantially flexible thermoplastic so that said pick guard device conforms to said portion of the surface adjacent to said sound hole of said stringed musical instrument when said back side of said final layer of said pick guard assembly is coupled to said portion of the surface adjacent to said sound hole of said stringed musical instrument.

12. The pick guard device having a pick guard assembly according to claim 11 wherein said thermoplastic is at least one of polyethylene, polypropylene, polyester, nylon and polyvinyl chloride.

13. The pick guard device having a pick guard assembly according to claim 11 further comprising a filler embedded in said flexible thermoplastic.

14. The pick guard device having a pick guard assembly according to claim 11 further comprising at least a foil coupled to said thermoplastic.

15. The pick guard device having a pick guard assembly according to claim 9 wherein at least a portion of said pick guard assembly is at least one of opaque, translucent and transparent.

16. A method for using a pick guard device comprising the steps of:
providing a pick guard assembly having a multiplicity of layers, each layer of said multiplicity of layers of said pick guard assembly coupled to an adjacent layer of said multiplicity of layers of said pick guard assembly; and
providing a back side of a final layer of said multiplicity of layers of said pick guard assembly adapted to be detachably coupled to a portion of a surface of a stringed musical instrument adjacent to a sound hole thereof, thereby permitting rapid non-adhesive coupling of said pick guard device to said portion of the surface adjacent to said sound hole of said stringed musical instrument and also permitting non-destructive decoupling of said pick guard device from said portion of the surface adjacent to said sound hole of said stringed musical instrument.

17. The method according to claim 16 further comprising the steps of:
providing a disposable layer of said pick guard assembly having a front side and a back side, said front side of said disposable layer of said pick guard assembly detachably coupled to said back side of said final layer of said multiplicity of layers of said pick guard assembly, said disposable layer of said pick guard assembly protecting said back side of said final layer of said multiplicity of layers of said pick guard assembly; and
providing said front side of said disposable layer of said pick guard assembly decoupled from said back side of said final layer of said multiplicity of layers of said pick guard assembly prior to coupling said back side of said final layer of said multiplicity of layers of said pick guard assembly to said portion of the surface adjacent to said sound hole of said stringed musical instrument.

18. The method according to claim 17 further comprising the steps of:
decoupling said back side of said final layer of said multiplicity of layers of said pick guard assembly of said pick guard device from said portion of the surface adjacent to said sound hole of said stringed musical instrument;
replacing said pick guard device with a replacement pick guard device, according to the mood of a person using said stringed musical instrument and also the desire of said person to portray a theme to an audience, said replacement pick guard device including a replacement pick guard assembly having a front side and a back side; and
coupling said back side of said replacement pick guard assembly of said replacement pick guard device to a portion of the surface adjacent to said sound hole of said stringed musical instrument.
